(19) United States
(12) Patent Application Publication
(10) Pub. No.: US 2026/0359566 A1
(43) Pub. Date: Nov. 12, 2026

(54) ENHANCING SPECULATIVE DECODING FOR LARGE LANGUAGE MODEL INFERENCE WITH LOOKUP TABLE

(71) Applicant: QUALCOMM Incorporated, San Diego, CA (US)

(72) Inventors: Apoorva Pushkar GOKHALE, San Diego, CA (US); Natarajan VAIDHYANATHAN, Carrboro, NC (US)

(21) Appl. No.: 19/204,121

(22) Filed: May 9, 2025

(51) Int. Cl. G06F 40/284; G06F 40/40

(52) U.S. Cl. CPC G06F 40/284; G06F 40/40

(57) ABSTRACT

Certain aspects of the present disclosure provide techniques and apparatus for generating content. In an example method, an input is received at a draft model. A draft continuation including one or more draft tokens is generated based on the input and using the draft model. Generating the draft continuation includes (i) performing a first lookup for the one or more draft tokens within the input using a first lookup function associated with the draft model, (ii) upon determining that the first lookup satisfies a first condition, performing a second lookup for the one or more draft tokens within a lookup table associated with the draft model using a second lookup function, and (iii) generating the draft continuation from the first lookup or the second lookup. A response to the input is generated, based on the draft continuation.

### INTRODUCTION

Aspects of the present disclosure relate to speculative decoding in generative artificial intelligence models.

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), and/or large multimodal models (LMMs) to process and generate output data. Often, machine learning models (especially LLMs, LVMs, and LMMs) have many parameters (e.g., millions or even billions), resulting in significant model size, as well as substantial computational expense and time to generate output using the model.

Some recent efforts to mitigate the computational expense of such generative models include speculative decoding, where a less computationally expensive model (referred to in some aspects as a “draft model”) can be used to generate a subset of the tokens in the output (rather than using the larger model, often referred to as the “target model,” for all tokens).

### BRIEF SUMMARY

Certain aspects of the present disclosure provide a processor-implemented method for generating content. The processor-implemented method includes receiving an input at a draft model. The processor-implemented method also includes generating a draft continuation comprising one or more draft tokens based on the input and using the draft model. Generating the draft continuation includes: performing a first lookup for the one or more draft tokens within the input using a first lookup function associated with the draft model; upon determining that the first lookup satisfies a first condition, performing a second lookup for the one or more draft tokens within a lookup table associated with the draft model using a second lookup function; and generating the draft continuation from the first lookup or the second lookup. The processor-implemented method further includes generating a response to the input, based on the draft continuation.

Certain aspects of the present disclosure provide a processing system for generating content. The processing system includes one or more memories comprising processor-executable instructions and one or more processors coupled to the one or more memories. The one or more processors are configured to execute the processor-executable instructions and cause the processing system to: receive an input at a draft model; generate a draft continuation comprising one or more draft tokens based on the input and using the draft model, wherein to generate the draft continuation, the one or more processors are configured to execute the processor-executable instructions and cause the processing system to: perform a first lookup for the one or more draft tokens within the input using a first lookup function associated with the draft model; upon determining that the first lookup satisfies a first condition, perform a second lookup for the one or more draft tokens within a lookup table associated with the draft model using a second lookup function; and generate the draft continuation from the first lookup or the second lookup; and generate a response to the input, based on the draft continuation.

Certain aspects of the present disclosure provide a processing system for generating content. The processing system includes means for receiving an input at a draft model. The processing system also includes means for generating a draft continuation comprising one or more draft tokens based on the input and using the draft model, comprising: means for performing a first lookup for the one or more draft tokens within the input using a first lookup function associated with the draft model; means for performing, upon determining that the first lookup satisfies a first condition, a second lookup for the one or more draft tokens within a lookup table associated with the draft model using a second lookup function; and means for generating the draft continuation from the first lookup or the second lookup. The processing system also includes means for generating a response to the input, based on the draft continuation.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 depicts an example workflow for using a fallback lookup table to perform speculative decoding, according to certain aspects of the present disclosure.

FIG. 2 depicts an example workflow for generating a fallback lookup table for speculative decoding, according to certain aspects of the present disclosure.

FIG. 3 is a flow diagram depicting an example method for using a fallback lookup table for speculative decoding, according to certain aspects of the present disclosure.

FIG. 4 is a flow diagram depicting an example method for generating content, according to some aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for providing improved content generation using speculative decoding. Specifically, in certain aspects of the present disclosure, techniques for improved speculative decoding using a fallback lookup table for a draft model are provided.

Many model architectures, such as large language models (LLMs), large vision models (LVMs), and large multimodal models (LMMs) have shown great promise in generating useful output data. However such generative models are often slow at inference time (e.g., taking substantial time to generate output tokens) and are similarly computationally expensive (e.g., consuming substantial memory, as well as processor time and energy, and resulting in substantial heat generation). As a result, a variety of techniques have been developed to accelerate the token generation rate and/or reduce the computational expense of the token generation. One such technique includes speculative decoding, where a drafting phase is performed to produce “draft” tokens using a relatively less computationally expensive and/or quicker draft model. These draft tokens can then undergo a verification phase to determine whether the draft tokens are “accepted” or “rejected” (e.g., by the target model) to produce the final set of output tokens. Speculative decoding techniques can accelerate (and/or reduce the computational expense associated with) the inference in applications of LLMs for text summarization, multi-turn chat, code refactoring, and/or other input-grounded generation tasks.

In some speculative decoding techniques, the draft model may be a pruned version of the target model chosen such that the draft model and target model have similar probability distributions. In other speculative decoding techniques, the draft model may be a smaller version of the target model (e.g., trained on millions of tokens, instead of hundreds of millions or billions of tokens). In some other speculative decoding techniques, the draft model may be implemented with a lookup algorithm (or search algorithm). By way of example, prompt lookup decoding (PLD) is a variant of speculative decoding that leverages an n-gram lookup algorithm as the draft model to find a proposed continuation to the context from the original input prompt and/or the output token(s) generated by the target model.

One potential drawback with conventional PLD techniques is that such PLD techniques may be limited to performing a lookup on tokens associated with the context of the current input prompt and/or previously generated output tokens. That is, while conventional PLD techniques can perform a lookup on tokens associated with the current context, these conventional PLD techniques may lack access to a larger knowledge base (e.g., global knowledge base) of common completions that can be searched for n-gram matches. In certain cases, limiting the completions available for searching for an n-gram match to the current input prompt and/or previously generated output tokens can mitigate the efficiency and performance of PLD techniques. For example, when the LLM is in the initial stage(s) of generating a response, such a limited number of completions available for searching for an n-gram match can lead to a “cold start” phenomenon where the PLD technique has difficulty in finding and proposing plausible continuations to the LLM.

Certain aspects of the present disclosure provide techniques for improved speculative decoding, and in particular, PLD-based variants of speculative decoding. In certain aspects, an a-priori knowledge base of common completions is generated from one or more datasets, such as one or more openly (e.g., publicly) available datasets. The knowledge base may be represented as a lookup table mapping n-grams to continuations. This lookup table may also include a support count representing the frequency of occurrence of the n-grams. In certain aspects, the lookup table may be arranged as a two-dimensional (2D) hash map (also known as a key-value table), where the n-gram is the first level key, the continuation token(s) are the second level key, and the support count of the n-gram and continuation token(s) in the dataset(s) is the value. The lookup table may be stored in persistent storage and subsequently loaded into memory at run-time.

In certain aspects, during the drafting phase, the draft model can use a first lookup algorithm to check the context of the current request being processed for the n-gram match. If there is no n-gram match within the context of the current request, then the draft model can use a second lookup algorithm to check the fallback lookup table for the n-gram match. In some cases, the first lookup algorithm and the second lookup algorithm may be the same lookup algorithm (e.g., same underlying n-gram lookup algorithm). For example, the first lookup algorithm may perform exact matching of token IDs of the most recently generated n-gram and all n-grams in the previous context (e.g., previously generated tokens as well as the prompt), and the second lookup algorithm may use the most recently generated n-gram to search the fallback lookup table. In other cases, the first lookup algorithm and the second lookup algorithm may be different (e.g., the first lookup algorithm and the second lookup algorithm may be different n-gram lookup algorithms with different parameters, for instance).

If there is an n-gram match within the fallback lookup table, then the draft model may use the continuation associated with the n-gram match as a draft continuation. The draft continuation may undergo a verification phase to determine whether one or more of the draft tokens associated with the draft continuation are “accepted” or “rejected” (e.g., by the slower and/or more computationally expensive target model) to produce a set of output tokens.

The techniques and apparatus described herein for improved speculative decoding, and in particular, PLD-based variants of speculative decoding may provide various technical advantages. For example, by leveraging commonly occurring continuations of tokens as a fallback option in case the initial n-gram lookup algorithm is unable to find a match in the context of the current request, the techniques described herein can significantly accelerate and/or reduce the computational expense of token generation in PLD techniques.

In some aspects, as used herein, a “target model” may generally refer to a generative machine learning model (also referred to as a “generative artificial intelligence model”) from which output generated data is desired. For example, the target model may correspond to an LLM being used to generate outputs. In some aspects, the target model may incur substantial latency and/or computational expense to generate output tokens (e.g., due to the size of the model). Similarly, as used herein, a “draft model” may generally refer to a smaller and/or less complex model that can be used as a surrogate for the target model in some cases (e.g., generating similar output, potentially with somewhat reduced accuracy or quality). Generally, the draft model may incur less latency and/or computational expense to generate output tokens, as compared to the target model, due to the smaller size and/or lower complexity of the draft model relative to the target model.

Generally, the particular architecture or techniques used to implement the draft model may vary depending on the particular implementation. For example, in some aspects, the draft model may be a machine learning model (e.g., a generative machine learning model). In some such aspects, the draft model may comprise a separate or discrete model from the target model, or may be implemented as a subset of the target model’s layers (e.g., where the draft model corresponds to every other layer of the target model). In another example, in some aspects, the draft model may be a non-machine- learning-based algorithm. In some such aspects, the draft model may be a lookup (or searching) algorithm, such as an n-gram lookup algorithm in PLD-based variants of speculative decoding, for example.

### Example Workflow for Using a Fallback Lookup Table to Perform Speculative Decoding in Generative Artificial Intelligence Models

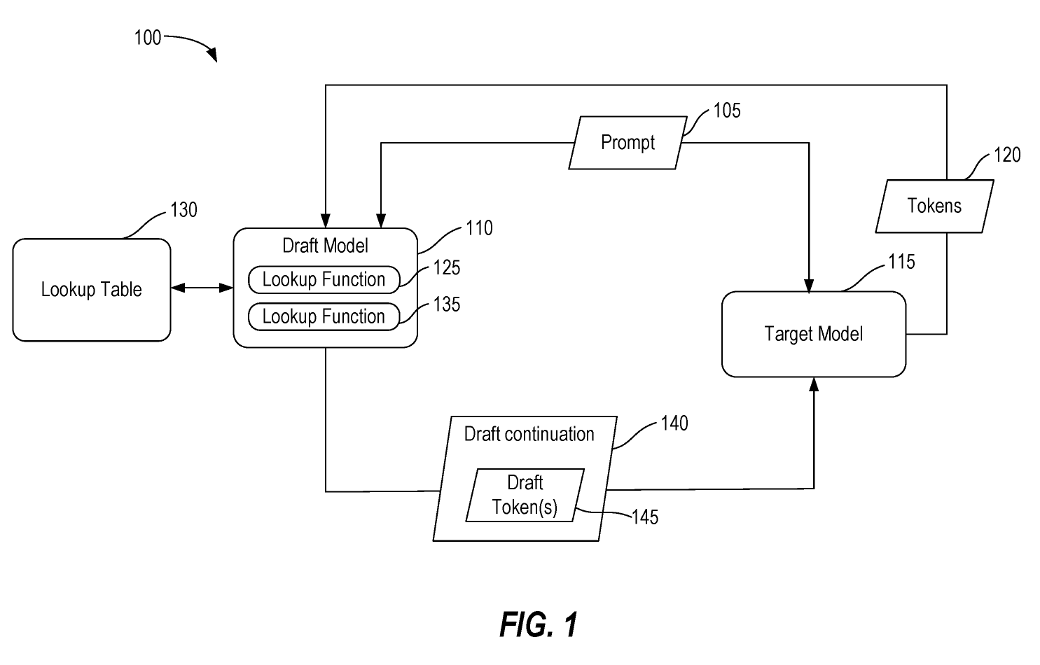

FIG. 1 depicts an example workflow 100 for using a fallback lookup table to perform speculative decoding, and in particular, a PLD-based variant of speculative decoding, according to certain aspects of the present disclosure. In certain aspects, the workflow 100 is performed by a speculative decoding system. That is, the workflow 100 may be performed by any computing system configured to perform speculative decoding (including PLD-based variants of speculative decoding), as discussed herein. In certain aspects, the workflow 100 may be performed by multiple discrete systems. For example, one computing system (e.g., a portable device) may implement the draft model, while another computing system (e.g., a server) may implement the target generative model. In other aspects, the same computing system may implement both the draft model and the target generative model.

In the illustrated example, a prompt 105 (also referred to in some aspects as a “query”) is accessed by a draft model 110 and a target model 115. As used herein, “accessing” data may generally include receiving, retrieving, obtaining, collecting, generating, or otherwise gaining access to the data. For example, the prompt 105 may be received from a user or entity that uses the machine learning model(s) to generate output. Generally, the particular content and format of the prompt 105 may vary depending on the particular implementation. For example, in some cases, the prompt 105 may comprise textual information (e.g., natural language text) for use as input to an LLM to generate textual output (e.g., a natural language text response).

In the depicted workflow 100, the target model 115 (also referred to in some aspects as the “primary model,” the “primary machine learning model,” and/or the “primary generative machine learning model”) generally corresponds to a generative machine learning model used to generate output data based on input prompts. For example, as discussed above, the target model 115 may correspond to an LLM, LVM, LMM, or the like. In some aspects, the target model 115 may be relatively computationally expensive (e.g., incurring substantial latency and/or computational resource usage) during runtime. Further, in the illustrated example, the draft model 110 (also referred to in some aspects as the “secondary model,” the “secondary machine learning model,” and/or the “secondary generative machine learning model”) generally corresponds to a model that can also be used to generate output data based on input prompts. In some aspects, as discussed above, the draft model 110 may be relatively less computationally expensive than the target model 115 (e.g., incurring less latency and/or computational resource usage, as compared to the target model 115) during runtime. For example, in certain speculative decoding techniques, the draft model 110 may be a machine learning model, such as a generative machine learning model. In other speculative decoding techniques, such as PLD-based variants of speculative decoding, the draft model 110 may be a non-machine-learning-based model and may be implemented with a lookup algorithm, such as an n-gram lookup algorithm, as an illustrative example.

In some aspects, the draft model 110 may be somewhat less accurate or reliable than the target model 115. However, not all tokens in a generated output are equally “difficult” to generate. Therefore, in some aspects, the draft model 110 may be reliably used to generate some tokens, even if the target model 115 is relied upon for other tokens. Knowing the “difficulty” of a given token (before drafting the token) is, generally speaking, nearly impossible. In some aspects, therefore, the depicted workflow 100 can be used to implement speculative decoding, and in particular, PLD. Generally, as discussed above, speculative decoding involves using the draft model 110 to generate at least some set of tokens in the output. These tokens generated by the draft model 110 (referred to as “draft tokens” in some aspects) can then be evaluated (e.g., using the target model 115) to verify the draft tokens. That is, the target model 115 may accept one or more of the draft tokens, and the target model 115 may reject one or more of the draft tokens (e.g., because the token is too dissimilar from what the target model 115 would have generated).

In some aspects, because the draft model 110 is less computationally complex than the target model 115, the set of draft tokens can be generated more rapidly and with less computational expense, as compared to generating the set using the target model 115 alone. Further, because the target model 115 may evaluate multiple draft tokens in parallel (e.g., evaluating the entire sequence of draft tokens at once), the target model 115 can be used to quickly verify the draft tokens. By combining these features, the workflow 100 can substantially accelerate the output generation process.

In the illustrated example, the target model 115 may process the prompt 105 to generate a set of one or more tokens 120. As used herein, a “token” corresponds to a unit of output of the model(s). Generally, the particular format and content of a token may vary depending on the particular implementation. For example, in some aspects, the tokens 120 comprise words, phrases, alphanumeric characters and/or symbols, and the like. Generally, the particular number of tokens 120 to be generated using the target model 115 may vary depending on the particular implementation. For example, in some aspects, the computing system may generate a single token 120 using the target model 115 in between each drafting phase (e.g., before using the draft model 110). As another example, the computing system may use the target model 115 to generate two or more tokens 120 between drafting phases. In yet another example, the computing system may not generate any tokens using the target model 115, e.g., prior to using the draft model 110.

In the illustrated workflow 100, these initial tokens 120 are provided, along with the prompt 105, to the draft model 110, to generate a draft continuation 140, which includes a new set of one or more tokens 145. In some aspects, as discussed above, the tokens 145 may be referred to as “draft” tokens to indicate that the tokens 145 were generated by the draft model 110. Generally, the particular number of tokens 145 to be generated using the draft model 110 may vary depending on the particular implementation.

As discussed above, in PLD-based variants of speculative decoding, the draft model 110 may be implemented with a lookup algorithm, such as an n-gram lookup algorithm. In certain aspects, the draft model 110 may generate the draft continuation 140 by (i) searching the current context of the prompt 105 and/or previously generated tokens 120 for an n-gram match using a lookup function (or algorithm) 125 and (ii) if no n-gram match is found, searching the lookup table 130 for an n-gram match using a lookup function (or algorithm) 135. If an n-gram match is found, the continuation (and tokens thereof) associated with the n-gram match may be used as the draft continuation 140.

In some aspects, as discussed above, the target model 115 may be used to verify the draft continuation 140. For example, the prompt 105, any tokens 120 that have already been drafted by the target model 115, and/or the set of draft tokens 145 may be provided as input, allowing the target model 115 to verify (e.g., accept) or reject each token of the sequence of draft tokens 145. For example, the target model 115 may generate a score for each token in the sequence of draft tokens 145, accepting tokens having a score above a threshold (e.g., indicating a higher probability that the target model 115 would have generated the same token) and rejecting tokens having a score below the threshold (e.g., indicating a lower probability that the target model 115 would have generated the same token).

In some aspects, this verification process also results in generation of a new next token 120 to be added to the sequence of (accepted) tokens. As illustrated, this updated sequence of tokens can then be provided to the draft model 110 to begin the next drafting phase, as discussed above. Although the illustrated example suggests that the target model 115 is used to generate the first token(s) in the output sequence, in some aspects, the draft model 110 may be used to generate the first token(s) (followed by verifying the first token(s) with the target model 115).

### Example Workflow for Generating a Fallback Lookup Table for Speculative Decoding

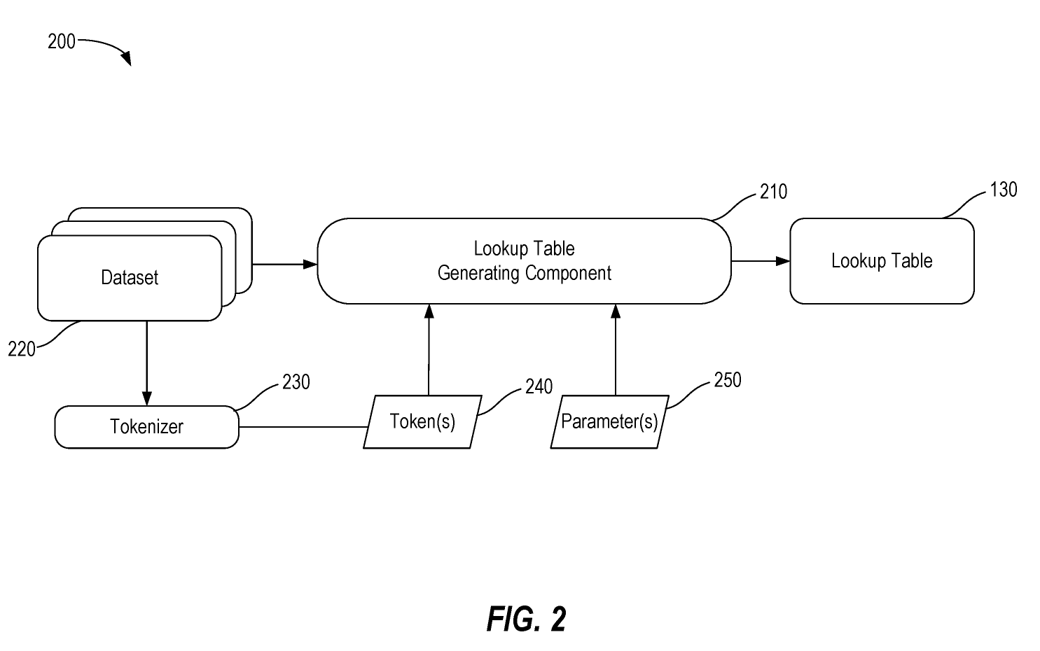

FIG. 2 depicts an example workflow 200 for generating a fallback lookup table for speculative decoding, and in particular, PLD, according to certain aspects of the present disclosure. In some aspects, the workflow 200 is performed by a computing system.

In the illustrated example, a lookup table generating component 210 accesses one or more datasets 220. As used herein, “accessing” data may generally include receiving, retrieving, obtaining, collecting, generating, or otherwise gaining access to the data. The datasets 220 are generally representative of publicly available (or openly available) datasets that include a variety of text content, such as dictionaries, books, articles, code, chat, websites, etc.

A tokenizer 230 may process the datasets 220 to generate a set of tokens 240. Although depicted as separate from the lookup table generating component 210 for conceptual clarity, in certain aspects, the tokenizer 230 may be implemented as part of the lookup table generating component 210. The lookup table generating component 210 may process the datasets 220, based on the tokens 240 and a set of parameters 250, to generate the lookup table 130. The set of parameters 250 may include a set of hyperparameters, such as the n-gram size (n) and the maximum draft length (k) (e.g., a defined maximum number of draft tokens that should be generated in a given drafting phase).

In certain aspects, the lookup table 130 may include a set of commonly occurring n-grams and possible k-gram continuations. The lookup table 130 may be arranged (or constructed) as a 2D hash map, where the n-gram is the first level key, the continuation tokens are the second level key, and the support count of the (n+k)-gram in the datasets 220 is the value. The lookup table 130 may be stored to persistent storage, loaded into memory (e.g., from a file on disk) at runtime, and leveraged as a fallback lookup table for PLD.

### Example Method for Using a Fallback Lookup Table for Speculative Decoding

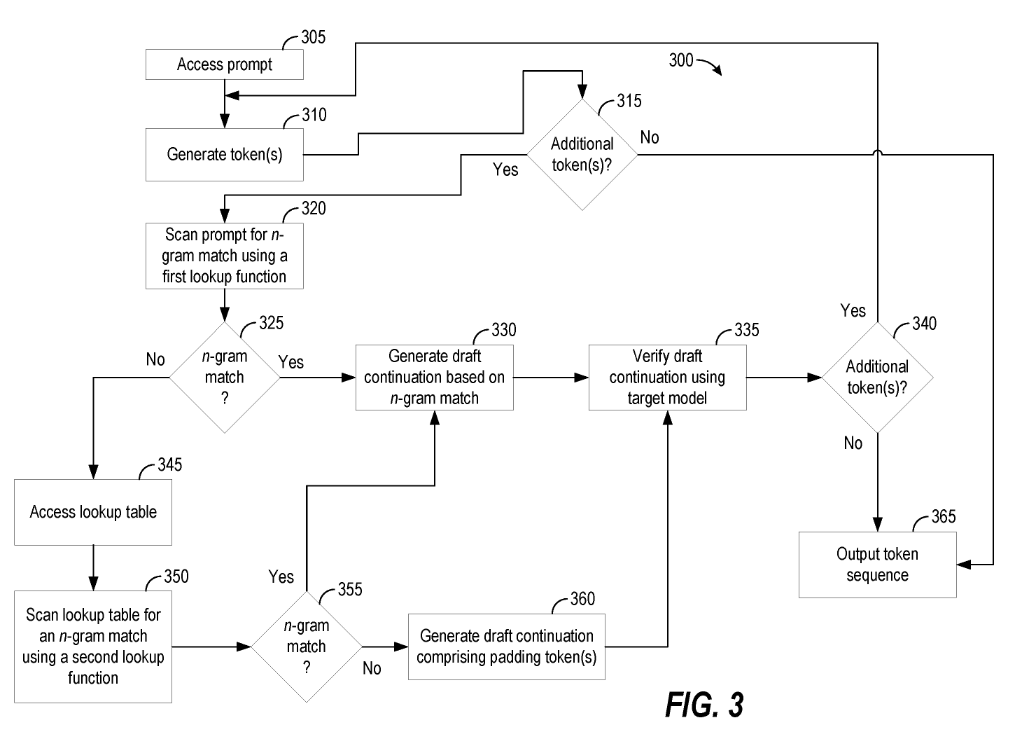

FIG. 3 is a flow diagram depicting an example method 300 for using a fallback lookup table (e.g., lookup table 130) for speculative decoding, and in particular, PLD-based variants of speculative decoding, according to certain aspects of the present disclosure. In some aspects, the method 300 is performed by a computing system (e.g., a speculative decoding system), such as the computing system discussed above with reference to FIG. 1.

At block 305, the computing system accesses a prompt (e.g., the prompt 105 of FIG. 1) to generate a generative machine learning model output. For example, as discussed above, the prompt may comprise text (e.g., natural language text) describing the desired output (e.g., asking a question, requesting an image be generated, and the like). The particular contents and format of the prompt may vary depending on the particular implementation.

At block 310, the computing system may generate one or more tokens (e.g., the tokens 120 of FIG. 1) based on the prompt. In some cases, generation of the token(s) may be accomplished using a target generative machine learning model (e.g., the target model 115 of FIG. 1). As discussed above, the target model generally corresponds to a generative machine learning model that can be used to generate output based on the prompt. In some aspects, the target model has relatively high computational complexity and/or latency (as compared to the draft model, discussed in more detail below). In some aspects, the computing system generates a single “initial” token at block 310 using the target model. In some aspects, the computing system may bypass block 310 during the initial iteration of generating output and/or subsequent iterations of generating output (e.g., the computing system may generate the token(s) using the draft model, rather than the target model). Generally, the computing system (e.g., the draft model or the target model) may generate any number of tokens at block 310.

At block 315, the computing system determines whether to generate at least one additional token for the output of the model. Generally, the computing system may evaluate a variety of criteria to determine whether to terminate the output generation. For example, in some aspects, the computing system may determine whether the most recently generated token(s) (e.g., generated at block 310) include an “end” token (or other token signifying the end of the generated output). As another example, in some aspects, the computing system may determine whether a defined (maximum) number of tokens have been generated (e.g., whether the generated output has reached the maximum length imposed on the models).

If, at block 315, the computing system determines that no additional tokens remain to be generated, the method 300 continues to block 365, discussed in more detail below. If, at block 315, the computing system determines that at least one additional token should be generated for the output, the method 300 continues to block 320.

At block 320, the computing system scans the prompt and previously generated tokens 120 (if any) for an n-gram match using a first lookup function (e.g., the lookup function 125 of FIG. 1) associated with a draft model (e.g., the draft model 110 of FIG. 1). As discussed above, in PLD-based variants of speculative decoding, the draft model may be implemented with a lookup algorithm, such as an n-gram lookup algorithm. As also discussed above, the draft model has relatively lower computational complexity and/or latency (as compared to the target model, as discussed above).

At block 325, the computing system determines whether there is an n-gram match within the prompt and/or previously generated tokens 120 (if any). In certain aspects, assuming the first lookup function is an n-gram lookup algorithm, the computing system may determine there is no n-gram match within the prompt and/or previously generated tokens (if any) at a given value of n for the n-gram lookup algorithm. In other aspects, assuming the first lookup function is an n-gram lookup algorithm, the computing system may determine there is no n-gram match within the prompt and/or previously generated tokens (if any) if, for each of multiple values of n for the n-gram lookup algorithm, there is no n-gram match within the prompt and/or previously generated tokens (if any) at the value of n. If the computing system determines there is no n-gram match within the prompt and/or previously generated tokens 120 (if any), then the method 300 proceeds to block 345. On the other hand, if there is an n-gram match within the prompt and/or previously generated tokens 120 (if any), then the method 300 proceeds to block 330.

At block 345, the computing system accesses a lookup table (e.g., the lookup table 130 of FIG. 1). At block 350, the computing system scans the lookup table for an n-gram match using a second lookup function (e.g., the lookup function 135 of FIG. 1) associated with the draft model. At block 355, the computing system determines whether there is an n-gram match within the lookup table. If not, then the method 300 proceeds to block 360. If there is an n-gram match within the lookup table, then the method 300 proceeds to block 330.

As discussed, the lookup table may include multiple candidate n-grams and, for each candidate n-gram, (i) a respective candidate continuation including one or more candidate tokens and (ii) an indication of a frequency of occurrence of the candidate continuation in one or more datasets (e.g., the dataset(s) 220 of FIG. 2). In some aspects, scanning the lookup table for an n-gram match using the second lookup function may involve (i) determining one or more n-gram matches with one or more candidate n-grams of the multiple candidate n-grams, (ii) selecting, from the one or more candidate n-grams, a candidate n-gram that satisfies a predetermined condition, and (iii) selecting the candidate continuation associated with the selected candidate n-gram as the draft continuation. In some such aspects, the condition may include having a highest frequency of occurrence among the one or more candidate n-grams. In some other such aspects, the condition may include being selected according to a predetermined probability distribution.

At block 360, the computing system generates a draft continuation that includes a set of padding tokens. For example, if an n-gram match is not found within the prompt, previously generated tokens 120, and the lookup table, the computing system may generate an empty proposal including padding tokens for scoring against the target model.

At block 330, the computing system generates a draft continuation based on the n-gram match (e.g., the n-gram match from the first lookup function or the n-gram match from the second lookup function). At block 335, the computing system verifies the draft continuation using the target model. For example, as discussed above, the computing system may process the draft tokens of the draft continuation as input to the target model, allowing the target model to accept or reject each draft token (or, in some aspects, allowing the computing system to score each draft token, where the scores can be evaluated to accept or reject each token).

At block 340, the computing system determines whether to generate at least one additional token for the output of the model. As discussed above, the computing system may generally evaluate a variety of criteria to determine whether to terminate the output generation. For example, in some aspects, the computing system may determine whether the most recently generated or verified token(s) (e.g., generated at block 330 and verified at block 335) include an “end” token (or other token signifying the end of the generated output). As another example, in some aspects, the computing system may determine whether a defined (maximum) number of tokens have been generated (e.g., whether the generated (and verified) output has reached the maximum length imposed on the models).

If, at block 340, the computing system determines that no additional tokens remain to be generated, the method 300 continues to block 365, discussed in more detail below. If, at block 340, the computing system determines that at least one additional token should be generated for the output, the method 300 returns to block 310 to generate another “next” token (e.g., using the target model or the draft model). In some aspects, as discussed above, the computing system may alternatively generate the new token while verifying the draft tokens. That is, the next token generated by the target model may be inherently or implicitly generated during the verification of draft tokens at block 335. The method 300 then continues to block 315, discussed above in more detail.

At block 365, the computing system outputs the generated token sequence. As discussed above, this sequence may generally include zero or more tokens generated by the target model, as well as zero or more draft tokens generated by the draft model and verified by the target model. For example, as discussed above, the computing system may output the sequence of tokens as a response to the entity that provided the prompt, or as input to a separate downstream computing system.

### Example Method for Generating Content

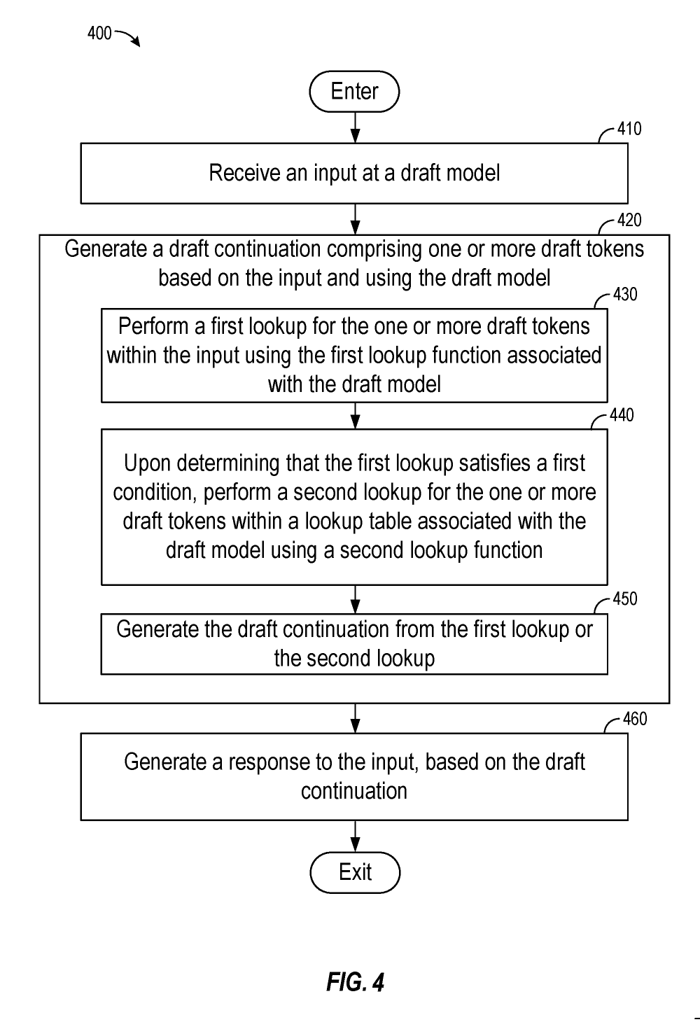

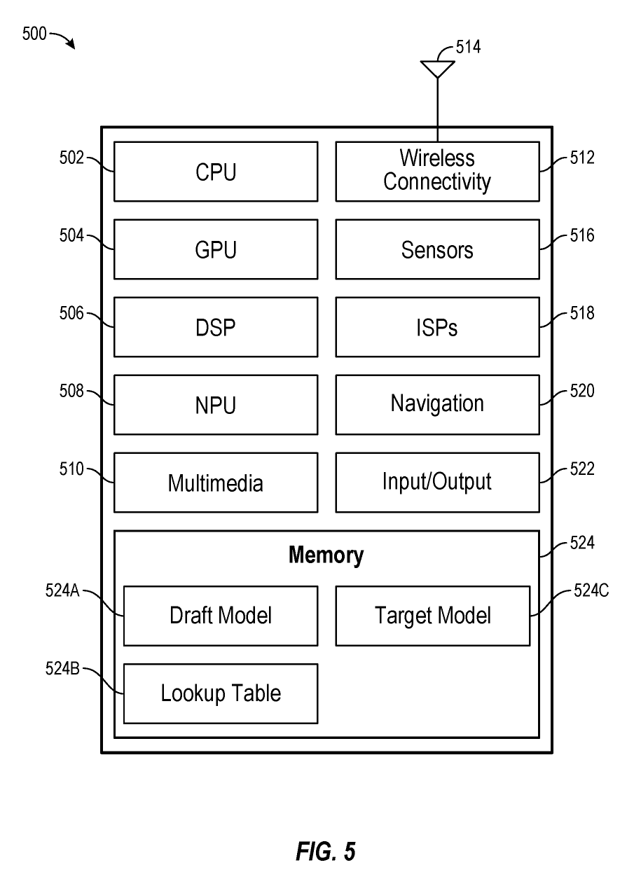

FIG. 4 is a flow diagram depicting an example method 400 for generating content, according to some aspects of the present disclosure. In some aspects, the method 400 is performed by a computing system (e.g., a speculative decoding system), such as the computing system discussed above with reference to FIG. 1 or the processing system discussed with reference to FIG. 5, as illustrative examples.

At block 410, the computing system may receive (or otherwise access) an input (e.g., prompt 105 and/or tokens 120) at a draft model (e.g., draft model 110).

At block 420, the computing system may generate a draft continuation (e.g., draft continuation 140) including one or more draft tokens (e.g., draft tokens 145) based on the input and using the draft model. Block 420 may involve performing blocks 430, 440, and 450.

At block 430, the computing system may perform a first lookup for the one or more draft tokens within the input using the first lookup function (e.g., lookup function 125) associated with the draft model.

At block 440, upon determining that the first lookup satisfies a first condition, the computing system may perform a second lookup for the one or more draft tokens within a lookup table associated with the draft model using a second lookup function (e.g., lookup function 135).

At block 450, the computing system may generate the draft continuation from the first lookup or the second lookup.

At block 460, the computing system may generate a response to the input, based on the draft continuation.

In certain aspects, the first lookup function includes an n-gram lookup algorithm. In some such aspects, performing the first lookup may include searching for an n-gram match with one or more tokens of the input.

In certain aspects, the first condition may include determining there is no n-gram match with the one or more tokens of the input at a predetermined value of n for the n-gram lookup algorithm.

In certain aspects, the first condition may include, for each of a plurality of predetermined values of n for the n-gram lookup algorithm, determining there is no n-gram match with the one or more tokens of the input at the predetermined value of n.

In certain aspects, the lookup table may include a plurality of candidate n-grams and, for each candidate n-gram of the plurality of candidate n-grams, (i) a respective candidate continuation comprising one or more candidate tokens and (ii) an indication of a frequency of occurrence of the candidate continuation in one or more datasets (e.g., datasets 220).

In certain aspects, the second lookup function may include an n-gram lookup algorithm. In some such aspects, performing the second lookup may include: determining one or more n-gram matches with one or more candidate n-grams of the plurality of candidate n-grams; selecting, from the one or more candidate n-grams, a candidate n-gram that satisfies a second condition; and selecting the candidate continuation associated with the selected candidate n-gram as the draft continuation.

In certain aspects, the second condition may include having a highest frequency of occurrence among the one or more candidate n-grams.

In certain aspects, the second condition may include being selected according to a predetermined probability distribution.

In certain aspects, the lookup table may be implemented by a key-value table. In some such aspects, the key-value table may use an n-gram as a first level key, a continuation associated with the n-gram as a second level key, and a frequency of occurrence of the continuation in one or more datasets as a value.

The various operations of methods described above may be performed by any suitable means capable of performing the corresponding functions. The means may include various hardware and/or software component(s) and/or module(s), including, but not limited to a circuit, an application specific integrated circuit (ASIC), or a processor.

### Example Processing System for Performing Speculative Decoding Using a Fallback Lookup Table for a Draft Model

FIG. 5 depicts an example processing system 500 for performing speculative decoding, and in particular, PLD-based variants of speculative decoding using a fallback lookup table for a draft model, such as described herein, for example, with respect to FIGS. 1 and 3-4.

The processing system 500 includes a central processing unit (CPU) 502, which in some examples may be a multi-core CPU. Instructions executed at the CPU 502 may be loaded, for example, from a program memory associated with the CPU 502 or may be loaded from a memory partition (e.g., of a memory 524).

The processing system 500 also includes additional processing components tailored to specific functions, such as a graphics processing unit (GPU) 504, a digital signal processor (DSP) 506, a neural processing unit (NPU) 508, and a connectivity component 512.

An NPU, such as the NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples, such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 508 is a part of one or more of the CPU 502, the GPU 504, and/or the DSP 506. These may be located on a user equipment (UE) in a wireless communication system or another computing device.

In some examples, the connectivity component 512 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 512 may be further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., global positioning system (GPS) or global navigation satellite system (GLONASS)) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an advanced reduced instruction set computing (RISC) machine (ARM) or fifth generation of RISC (RISC-V) instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes a draft model 524A, a lookup table 524B, and a target model 524C (e.g., a generative model). The depicted components, and others not depicted, may be configured to perform various aspects of the methods described herein.

Generally, the processing system 500 and/or components thereof may be configured to perform the methods described herein.

### Example Clauses

Implementation details of various aspects of the present disclosure are described in the following numbered clauses.

Clause 1: A processor-implemented method for generating content, the processor-implemented method comprising: receiving an input at a draft model; generating a draft continuation comprising one or more draft tokens based on the input and using the draft model, comprising: performing a first lookup for the one or more draft tokens within the input using a first lookup function associated with the draft model; upon determining that the first lookup satisfies a first condition, performing a second lookup for the one or more draft tokens within a lookup table associated with the draft model using a second lookup function; and generating the draft continuation from the first lookup or the second lookup; and generating a response to the input, based on the draft continuation.

Clause 2: The processor-implemented method of Clause 1, wherein: the first lookup function comprises an n-gram lookup algorithm; and performing the first lookup comprises searching for an n-gram match with one or more tokens of the input.

Clause 3: The processor-implemented method of Clause 2, wherein the first condition comprises determining there is no n-gram match with the one or more tokens of the input at a predetermined value of n for the n-gram lookup algorithm.

Clause 4: The processor-implemented method of Clause 2, wherein the first condition comprises, for each of a plurality of predetermined values of n for the n-gram lookup algorithm, determining there is no n-gram match with the one or more tokens of the input at the predetermined value of n.

Clause 5: The processor-implemented method in accordance with any of Clauses 1-4, wherein the lookup table comprises a plurality of candidate n-grams and, for each candidate n-gram of the plurality of candidate n-grams, (i) a respective candidate continuation comprising one or more candidate tokens and (ii) an indication of a frequency of occurrence of the candidate continuation in one or more datasets.

Clause 6: The processor-implemented method of Clause 5, wherein: the second lookup function comprises an n-gram lookup algorithm; and performing the second lookup comprises: determining one or more n-gram matches with one or more candidate n-grams of the plurality of candidate n-grams; selecting, from the one or more candidate n-grams, a candidate n-gram that satisfies a second condition; and selecting the candidate continuation associated with the selected candidate n-gram as the draft continuation.

Clause 7: The processor-implemented method of Clause 6, wherein the second condition comprises having a highest frequency of occurrence among the one or more candidate n-grams.

Clause 8: The processor-implemented method of Clause 6, wherein the second condition comprises being selected according to a predetermined probability distribution.

Clause 9: The processor-implemented method in accordance with any of Clauses 1-8, wherein the lookup table is implemented by a key-value table.

Clause 10: The processor-implemented method of Clause 9, wherein the key-value table uses an n-gram as a first level key, a continuation associated with the n-gram as a second level key, and a frequency of occurrence of the continuation in one or more datasets as a value.

Clause 11: A processing system comprising: a memory comprising processor-executable instructions; and one or more processors coupled to the one or more memories and configured to execute the processor-executable instructions and cause the processing system to perform a method in accordance with any of Clauses 1-10.

Clause 12: A mobile device comprising the processing system of Clause 11.

Clause 13: A processing system comprising means for performing a method in accordance with any of Clauses 1-10.

Clause 14: A non-transitory computer-readable medium comprising computer-executable instructions that, when executed by one or more processors of a processing system, cause the processing system to perform a method in accordance with any of Clauses 1-10.

Clause 15: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for generating content, comprising:
one or more memories comprising processor-executable instructions; and
one or more processors coupled to the one or more memories and configured to execute the processor-executable instructions and cause the processing system to:
receive an input at a draft model;
generate a draft continuation comprising one or more draft tokens based on the input and using the draft model, wherein to generate the draft continuation, the one or more processors are configured to execute the processor-executable instructions and cause the processing system to:
perform a first lookup for the one or more draft tokens within the input using a first lookup function associated with the draft model;
upon determining that the first lookup satisfies a first condition, perform a second lookup for the one or more draft tokens within a lookup table associated with the draft model using a second lookup function; and
generate the draft continuation from the first lookup or the second lookup; and
generate a response to the input, based on the draft continuation.

2. The processing system of claim 1, wherein:
the first lookup function comprises an n-gram lookup algorithm; and
to perform the first lookup, the one or more processors are configured to execute the processor-executable instructions and cause the processing system to search for an n-gram match with one or more tokens of the input.

3. The processing system of claim 2, wherein the first condition comprises determining there is no n-gram match with the one or more tokens of the input at a predetermined value of n for the n-gram lookup algorithm.

4. The processing system of claim 2, wherein the first condition comprises, for each of a plurality of predetermined values of n for the n-gram lookup algorithm, determining there is no n-gram match with the one or more tokens of the input at the predetermined value of n.

5. The processing system of claim 1, wherein the lookup table comprises a plurality of candidate n-grams and, for each candidate n-gram of the plurality of candidate n-grams, (i) a respective candidate continuation comprising one or more candidate tokens and (ii) an indication of a frequency of occurrence of the candidate continuation in one or more datasets.

6. The processing system of claim 5, wherein:
the second lookup function comprises an n-gram lookup algorithm; and
to perform the second lookup, the one or more processors are configured to execute the processor-executable instructions and cause the processing system to:
determine one or more n-gram matches with one or more candidate n-grams of the plurality of candidate n-grams;
select, from the one or more candidate n-grams, a candidate n-gram that satisfies a second condition; and
select the candidate continuation associated with the selected candidate n-gram as the draft continuation.

7. The processing system of claim 6, wherein the second condition comprises having a highest frequency of occurrence among the one or more candidate n-grams.

8. The processing system of claim 6, wherein the second condition comprises being selected according to a predetermined probability distribution.

9. The processing system of claim 1, wherein the lookup table is implemented by a key-value table.

10. The processing system of claim 9, wherein the key-value table uses an n-gram as a first level key, a continuation associated with the n-gram as a second level key, and a frequency of occurrence of the continuation in one or more datasets as a value.

11. The processing system of claim 1, wherein the processing system comprises a mobile device.

12. A processor-implemented method for generating content, the processor-implemented method comprising:
receiving an input at a draft model;
generating a draft continuation comprising one or more draft tokens based on the input and using the draft model, comprising:
performing a first lookup for the one or more draft tokens within the input using a first lookup function associated with the draft model;
upon determining that the first lookup satisfies a first condition, performing a second lookup for the one or more draft tokens within a lookup table associated with the draft model using a second lookup function; and
generating the draft continuation from the first lookup or the second lookup; and
generating a response to the input, based on the draft continuation.

13. The processor-implemented method of claim 12, wherein:
the first lookup function comprises an n-gram lookup algorithm; and
performing the first lookup comprises searching for an n-gram match with one or more tokens of the input.

14. The processor-implemented method of claim 13, wherein the first condition comprises determining there is no n-gram match with the one or more tokens of the input at a predetermined value of n for the n-gram lookup algorithm.

15. The processor-implemented method of claim 13, wherein the first condition comprises, for each of a plurality of predetermined values of n for the n-gram lookup algorithm, determining there is no n-gram match with the one or more tokens of the input at the predetermined value of n.

16. The processor-implemented method of claim 12, wherein the lookup table comprises a plurality of candidate n-grams and, for each candidate n-gram of the plurality of candidate n-grams, (i) a respective candidate continuation comprising one or more candidate tokens and (ii) an indication of a frequency of occurrence of the candidate continuation in one or more datasets.

17. The processor-implemented method of claim 16, wherein:
the second lookup function comprises an n-gram lookup algorithm; and
performing the second lookup comprises:
determining one or more n-gram matches with one or more candidate n-grams of the plurality of candidate n-grams;
selecting, from the one or more candidate n-grams, a candidate n-gram that satisfies a second condition; and
selecting the candidate continuation associated with the selected candidate n-gram as the draft continuation.

18. The processor-implemented method of claim 17, wherein the second condition comprises having a highest frequency of occurrence among the one or more candidate n-grams.

19. The processor-implemented method of claim 17, wherein the second condition comprises being selected according to a predetermined probability distribution.

20. A processing system for generating content, comprising:
means for receiving an input at a draft model;
means for generating a draft continuation comprising one or more draft tokens based on the input and using the draft model, comprising:
means for performing a first lookup for the one or more draft tokens within the input using a first lookup function associated with the draft model;
means for performing, upon determining that the first lookup satisfies a first condition, a second lookup for the one or more draft tokens within a lookup table associated with the draft model using a second lookup function; and
means for generating the draft continuation from the first lookup or the second lookup; and
means for generating a response to the input, based on the draft continuation.
